(19) United States
(12) Patent Application Publication
(10) Pub. No.: US 2008/0083070 A1
(43) Pub. Date: Apr. 10, 2008

(54) Adjuster for wheel brake cylinder

(76) Inventor: Chia Hao Huang, Taiping City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/727,997

(22) Filed: Mar. 29, 2007

(30) Foreign Application Priority Data
Oct. 4, 2006 (TW) 095136919

(51) Int. Cl. B25F 1/00

(52) U.S. Cl. 7/100

(57) ABSTRACT

A wheel brake cylinder adjuster includes a gas in a gas chamber, a piston, a push rod, a positioning portion, a stop plate, a control module, and several relief holes. They are connected so that the gas pushes the piston to move the push rod. A gas adjusting module is employed to relieve the gas. The invention achieves the goals of having a simple structure, a lower cost, and the function of re-positioning the push rod.

### BACKGROUND OF THE INVENTION

1. Field of Invention

The invention relates to an adjuster for the wheel brake cylinder and, in particular, to a wheel brake cylinder adjusting device with a simple structure for re-positioning its push rod and reducing the production cost.

2. Related Art

The brake is an important function for operating a vehicle. With the driver's stepping on the brake, the wheel brake cylinder gradually exposes itself as the brake lining wears out. When the braking distance of the vehicle becomes longer, it means that the braking lining needs to be replaced. In this case, the wheel brake cylinder axis has to be rotated and pushed to its original position for replacement.

The conventional brake cylinder adjuster is shown in FIG. 4. It includes a block 7 having a first end installed with a fixing plate 71 and a second end; a handle 72 with one end connected to the second end of the block 7 and the other end connected with a connector 721; a push rod 73 penetrating through the block 7 and the handle 72 with one end provided with a pushing plate 731 for pressing against the brake cylinder and the other end provided with a lever 732 for rotating the push rod 73; an inlet valve 74 disposed on one side of the handle 72 for selectively controlling high-pressure gas to enter the block 7 via the connector 721, thus pushing a piston (not shown) and displacing the push rod 73; a relief valve 75 disposed on the other side of the handle 72 for releasing the high-pressure gas inside the block 7 so that the push rod 73 can be readily pulled back to its initial position.

However, the brake cylinder adjuster with the relief valve has a complicated structure. Correspondingly, its production cost is more expensive. It is thus highly desirable to improve its structure.

### SUMMARY OF THE INVENTION

An objective of the invention is to solve the foregoing problems and provide a brake cylinder adjuster. It uses a relief hole provided in a gun pipe to achieve the goal of re-positioning the push rod.

Another objective of the invention is to simplify the relief component of the adjuster. The combination of a relief hole and a gas adjusting module achieves the goal of releasing gas. Therefore, the invention has the advantages of a simpler structure and a lower production cost.

To achieve the above objectives, the invention includes a gun body, a control module, a positioning portion, a push rod, and a stop plate.

The gun body has to gun pipe and a handle portion for the flow of gas. The gun pipe has a first accommodation space inside. The outer rim of the gun pipe has several relief holes. A gas adjusting module is disposed in one of the relief holes. The handle portion extends downward and connects to the rear end of the gun pipe. The handle portion has a gas chamber and a second accommodation space inside. A first gas channel is formed between the second accommodation space and the gas chamber. A second gas channel is formed between the second accommodation space and the first accommodation space.

The control module is disposed inside the second accommodation space for controlling gas to flow from the second accommodation space to the first accommodation space. The positioning portion is mounted on the end of the gun pipe opposite to the handle portion. The push rod penetrates through the gun body and protrudes from both ends. A lever is disposed near the rear end of the push rod. The outer side of the push rod is disposed in sequence the positioning portion, a piston, and the lever. The stop plate is connected to the front end of the push rod and has several bumps.

### BRIEF DESCRIPTION OF THE DRAWINGS

The invention will become more fully understood from the detailed description given herein below illustration only, and thus is not limitative of the present invention, and wherein:

FIG. 1 shows the appearance of the invention;

FIG. 2 is a cross-sectional view of the invention;

FIG. 3 schematically depicts how the invention works;

FIG. 4 is a locally enlarged view showing the relation between the gas adjusting module and the relief hole;

FIG. 5 is another locally enlarged view showing the relation between the gas adjusting module and the relief hole; and

FIG. 6 is a schematic view of the relief valve in the conventional wheel brake cylinder.

### DETAILED DESCRIPTION OF THE INVENTION

The present invention will be apparent from the following detailed description, which proceeds with reference to the accompanying drawings, wherein the same references relate to the same elements.

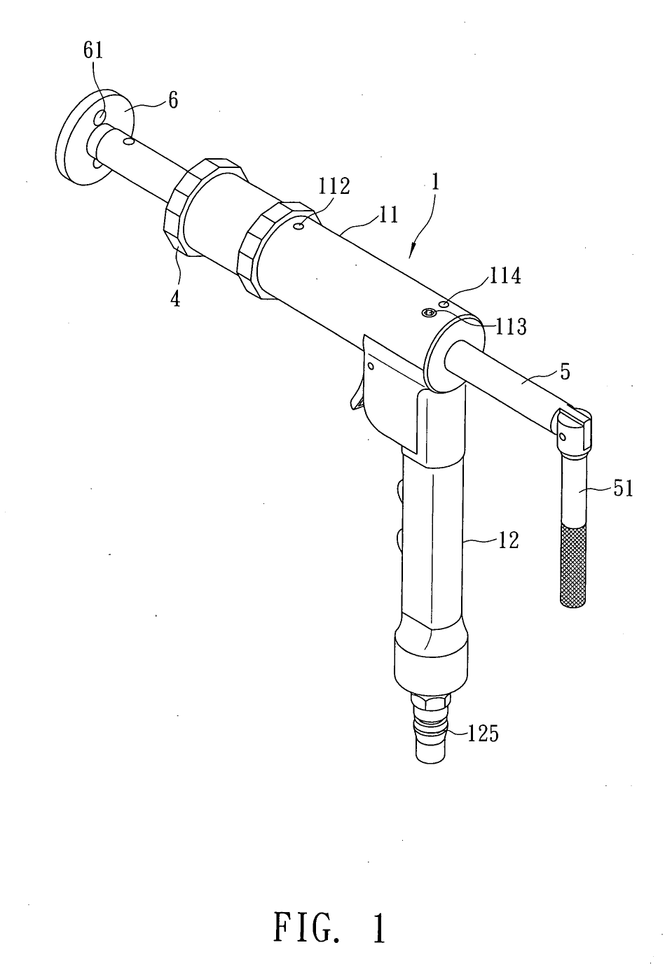

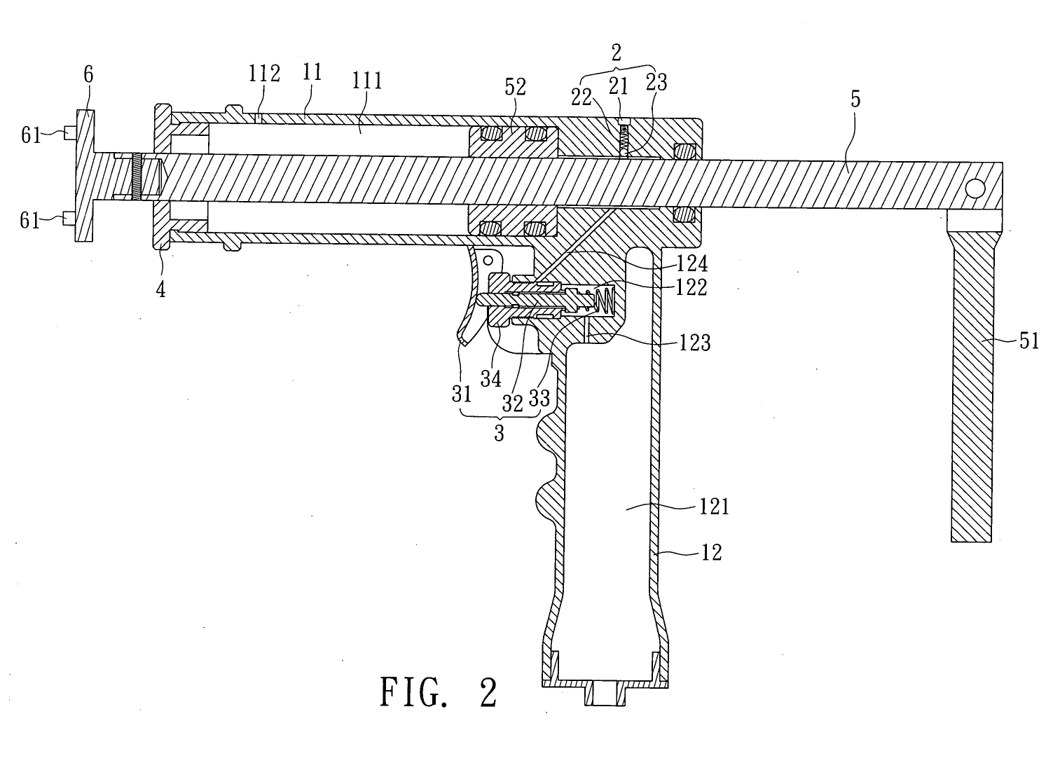

A preferred embodiment of the brake cylinder adjuster according to the invention is shown in FIGS. 1 and 2. It includes a gun body 1, a control module 3, a positioning portion, 4 a push rod 5, and a stop plate 6.

The gun body 1 has to gun pipe 11 and a handle portion 12 for the flow of gas therein. The gun pipe 11 has a first accommodation space 111 inside. The outer rim of the gun pipe 11 has a first relief hole 112, a second relief hole 113, and a third relief hole 114. The second relief hole 113 and the third relief hole 114 subtend an angle ?. The second relief hole 113 and the third relief hole 114 are connected at the intersection with the first accommodation space 111. A gas adjusting module 2 is disposed in the second relief hole 113. In this embodiment, the gas adjusting module 2 consists of a locking element 21, an elastic element 22, and a steel ball 23. The handle portion 12 extends downward and connects to the rear end of the gun pipe 11. The handle portion 12 has a connector 125 and a gas chamber 121 and a second accommodation space 122 inside. A first gas channel 123 is formed between the second accommodation space 122 and the gas chamber 121. A second gas channel 124 is formed between the second accommodation space 122 and the first accommodation space 111.

The control module 3 is disposed inside the second accommodation space 122 for controlling gas to flow from the second accommodation space 122 to the first accommodation space 111. The control module 3 includes a pressing board 31, an action rod 32, a spring 33, and a push element 34. The spring 33 is mounted on the rear end of the action rod 32. The push element 34 is mounted on the front end of the action rod 32. The front end of the action rod 32 protrudes from the push element 34 and pushes against the pressing board 31.

The positioning portion 4 is mounted on the end of the gun pipe 11 opposite to the handle portion 12.

The push rod 5 penetrates through the gun body 1 and protrudes from both ends. A lever 51 is disposed near the rear end of the push rod 5. The outer side of the push rod 5 is disposed in sequence the positioning portion 4, a piston 52, and the lever 51.

The stop plate 6 is connected to the front end of the push rod 5 and has several bumps 61.

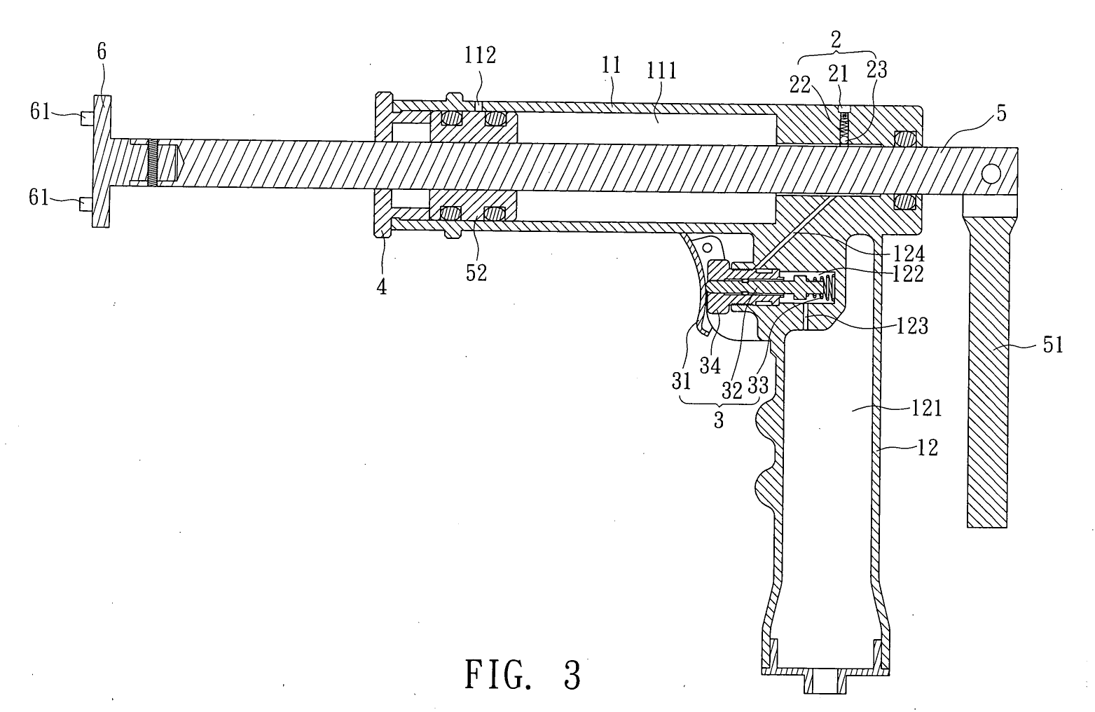

When using the invention, the user first fills a gas into the gas chamber 121 from a gas source (not shown). After the gas chamber 121 is filled with the gas, it flows from the gas chamber 121 to the second accommodation space 122 via the first gas channel 123 in between. The bumps 61 are in line with the left-handed or right-handed screw thread of the brake cylinder and pushes against the pressing board 31. The pressing board 31 moves the action rod 32 backward in the second accommodation space 122. During the backward motion of the action rod 32, the gas flows via the second gas channel into the first accommodation space 111. Since the steel ball 23 is disposed at the intersection of the second relief hole 113, the third relief hole 114, and the first accommodation space 111, the gas is prevented from leaking out via the third relief hole 114. The gas then pushes the piston 52 to move the push rod 5 forward. As shown in FIG. 3, the bumps 61 are positioned. The user can rotate the lever 51 to rotate the screw thread.

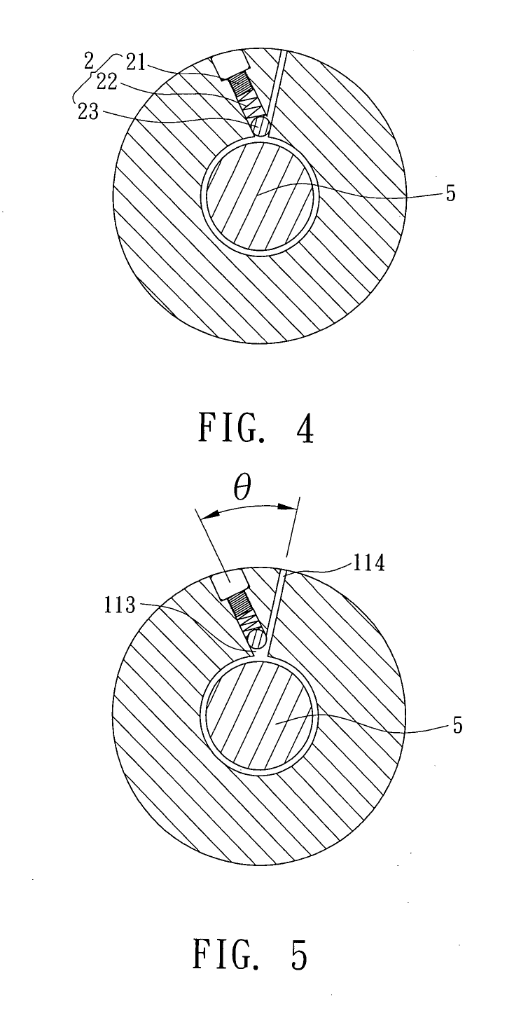

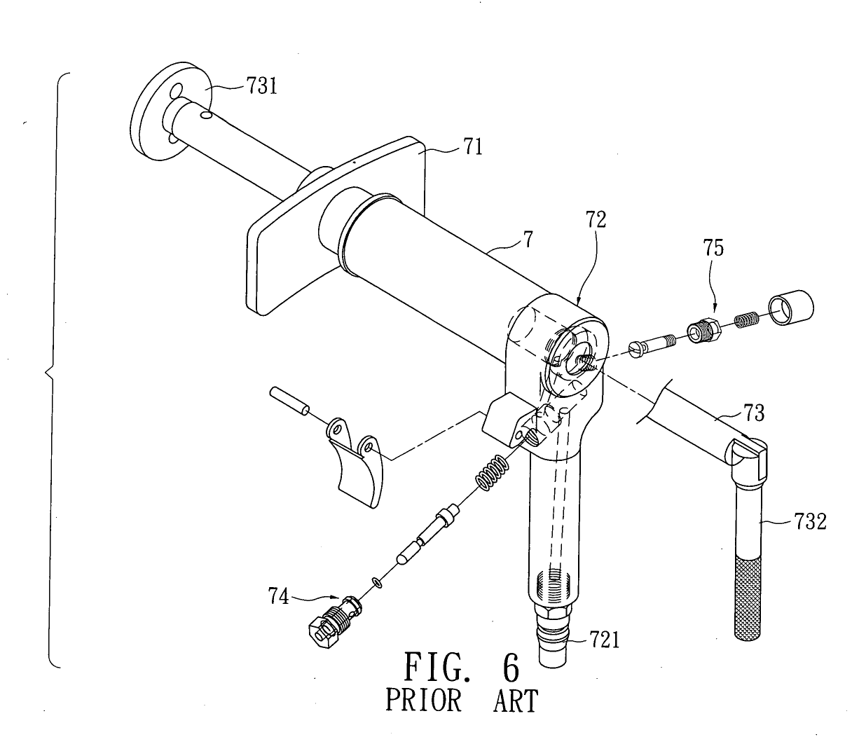

After the action of rotating the screw thread is done, the gas inside the first accommodation space 111 pushes the steel ball 23 upward to pull the push rod 5 back to its initial position. The steel 23 no longer blocks the intersection of the second relief hole 113, the third relief hole 114, and the first accommodation space 111, as shown in FIGS. 4 and 5. Therefore, the gas leaks out via the third relief hole 114, instead of pushing the piston 52. In this case, the user pulls the lever backward, thus readily brining the push rod 5 backward to its initial position.

In summary, the invention utilizes a gas to push the piston and the push rod. The push rod moves the bumps on the stop plate to rotate the lever, thereby driving the wheel brake cylinder. The combination of the relief holes and the gas adjusting module according to the invention can achieve the action of releasing the gas. Therefore, the invention has the advantages of a simple structure, a lower production cost, and re-positioning the push rod.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A brake cylinder adjuster, comprising:
a gun body, which has a gun pipe and a handle portion for the flow of gas, the gun pipe having a first accommodation space inside and the outer rim of the gun pipe having a plurality of relief holes; wherein a gas adjusting module is disposed in one of the relief holes, the handle portion extends downward and connects to the rear end of the gun pipe, the handle portion has a gas chamber and a second accommodation space inside, a first gas channel is formed between the second accommodation space and the gas chamber, and a second gas channel is formed between the second accommodation space and the first accommodation space;
a control module, which is disposed inside the second accommodation space for controlling gas to flow from the second accommodation space to the first accommodation space;
a positioning portion, which is mounted on the end of the gun pipe opposite to the handle portion;
a push rod, which penetrates through the gun body and protrudes from both ends; wherein a lever is disposed near the rear end of the push rod, and the outer side of the push rod is disposed in sequence the positioning portion, a piston, and the lever; and
a stop plate, which is connected to the front end of the push rod and has several bumps.

2. The brake cylinder adjuster of claim 1, wherein the plurality of relief holes are a first relief hole, a second relief hole, and a third relief hole with the second relief hole and the third relief hole subtending an angle and the second relief hole and the third relief hole connecting each other at the intersection with the first accommodation space.

3. The brake cylinder adjuster of claim 1, wherein the gas adjusting module includes a locking element, an elastic element, and a steel ball.

4. The brake cylinder adjuster of claim 1, wherein the control module includes a pressing board, an action rod, a spring, and a push element, the spring being mounted on the rear end of the action rod, the push element being mounted on the front end of the action rod, and the front end of the action rod protruding from the push element and pushing against the pressing board.

5. The brake cylinder adjuster of claim 1, wherein a connector is disposed at the bottom of the handle portion.

6. The brake cylinder adjuster of claim 2, wherein the gas adjusting module is disposed inside the second relief hole.
